(19) United States
(12) Patent Application Publication
(10) Pub. No.: US 2025/0283734 A1
(43) Pub. Date: Sep. 11, 2025

(54) POSITION DETECTION DEVICE AND ACTUATOR

(71) Applicant: SMC CORPORATION, Tokyo (JP)

(72) Inventor: Norimasa OZAKI, Tsukubamirai-shi (JP)

(73) Assignee: SMC CORPORATION, Tokyo (JP)

(21) Appl. No.: 19/068,269

(22) Filed: Mar. 3, 2025

(30) Foreign Application Priority Data
Mar. 8, 2024 (JP) 2024-036084

(51) Int. Cl. G01D 5/14; H02J 50/00

(52) U.S. Cl. CPC G01D 5/14; H02J 50/00

(57) ABSTRACT

A position detection device includes a first sensor that outputs a first detection signal when a piston is located within a first detection range, a detection unit that detects the piston position based on the first detection signal, an antenna that receives power wirelessly, a power supply line through which the power is supplied from the antenna to the first sensor when the piston is located within the first detection range, and a power output line configured to output, when the piston is located outside the first detection range, the power to a sensor module used for detecting the piston position.

### CROSS-REFERENCE TO RELATED APPLICATIONS

This application is based upon and claims the benefit of priority from Japanese Patent Application No. 2024-036084 filed on Mar. 8, 2024, the contents of which are incorporated herein by reference.

### BACKGROUND OF THE INVENTION

### Field of the Invention

The present invention relates to a position detection device and an actuator.

### Description of the Related Art

JP 2023-078294 A discloses a wireless antenna module for communication. Electric power is supplied to the first and second module bodies, which are two wireless antenna modules, from a battery that stores wirelessly supplied power. The first module body wirelessly transmits a sensor detection signal from a first device body to a master device (GW unit). The second module body wirelessly transmits a sensor detection signal from a second device body to the master device (GW unit).

### SUMMARY OF THE INVENTION

The wirelessly supplied power is often weak. Therefore, if weak power is supplied to both of the two wireless antenna modules, a power shortage may occur in any of the wireless antenna modules.

The present invention has the object of solving the aforementioned problems.

A first aspect of the present invention is a position detection device for detecting a piston position of a piston that is attached to a cylinder and moves in the cylinder, comprising: a first sensor that outputs a first detection signal in a case where the piston is located within a first detection range; a detection unit that detects the piston position based on the first detection signal; a communication device that transmits the piston position detected by the detection unit to an external device; an antenna that receives power wirelessly; a power supply line through which the power is supplied from the antenna to the first sensor in a case where the piston is located within the first detection range; and a power output line configured to externally output, in a case where the piston is located outside the first detection range, the power to a sensor module used for detecting the piston position.

A second aspect of the present invention is an actuator that includes the position detection device according to the first aspect, the sensor module, the cylinder, and the piston.

The present invention can reduce the possibility of the shortage of wirelessly supplied power.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a diagram illustrating an actuator;

FIG. 2 is a diagram for explaining a configuration example of a first sensor and a second sensor, and power supply to the first sensor and the second sensor according to a piston position;

FIG. 3 is a diagram for explaining the configuration example of the first sensor and the second sensor, and power supply to the first sensor and the second sensor according to a piston position;

FIG. 4 is a diagram for explaining another configuration example of a first sensor and a second sensor, and power supply to the first sensor and the second sensor according to a piston position; and

FIG. 5 is a diagram for explaining another configuration example of the first sensor and the second sensor, and power supply to the first sensor and the second sensor according to a piston position.

### DETAILED DESCRIPTION OF THE INVENTION

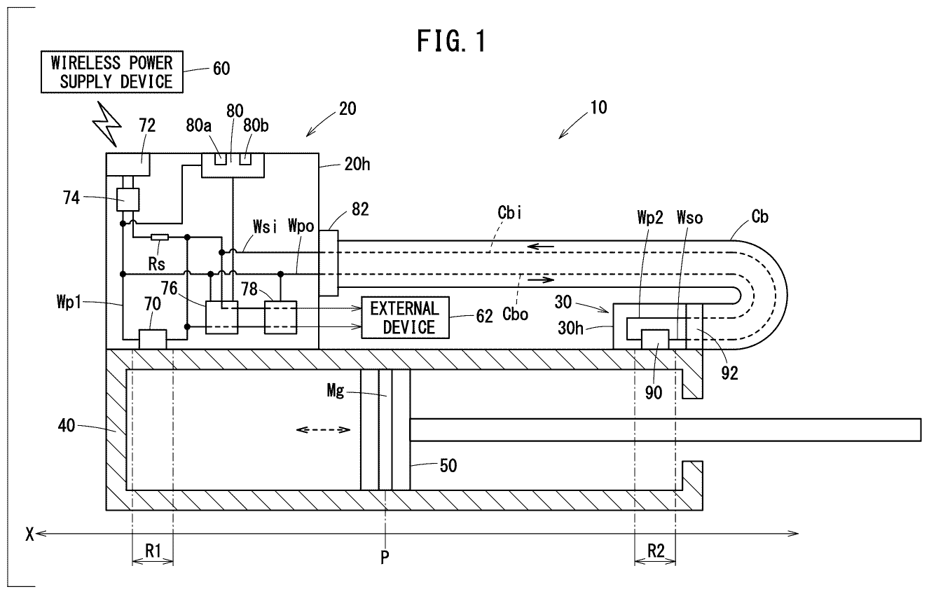

FIG. 1 is a diagram illustrating an actuator 10. The actuator 10 is used for conveying a workpiece or the like and has a position detection device 20, a sensor module 30, a cylinder 40, and a piston 50. The position detection device 20 and the sensor module 30 are both mounted on the outer surface of the cylinder 40 and are connected to each other through a cable Cb.

The piston 50 moves in the X direction in the cylinder 40. That is, the moving direction of the piston 50 is the X direction. The position detection device 20 detects a piston position P of the piston 50 in the X direction. The piston 50 is provided with a magnet Mg. In the example shown in FIG. 1, the piston position P corresponds to the position of the magnet Mg.

The position detection device 20 receives power from the wireless power supply device 60 wirelessly. The position detection device 20 and the sensor module 30 are used for detecting the piston position P. When the piston 50 moves in the cylinder 40 in the X direction, a first detection signal or a second detection signal regarding the piston position P of the piston 50 may be output from the position detection device 20 or the sensor module 30. The output of the first detection signal or the second detection signal is performed using the power received by the position detection device 20 wirelessly. The position detection device 20 detects the piston position P based on the first detection signal or the second detection signal.

The position detection device 20 transmits the detected piston position P to an external device 62. The external device 62 is, for example, a management device that manages the position detection device 20 or the actuator 10. The transmission of the piston position P from the position detection device 20 to the external device 62 is performed by wireless communication or wired communication.

The configurations of the position detection device 20 and the sensor module 30 will be further described with reference to FIG. 1. The position detection device 20 includes a first sensor 70, an antenna 72, a power conversion circuit 74, a detection unit 76, a communication device 78, an indicator 80, and a connector 82. The first sensor 70, the antenna 72, the power conversion circuit 74, the detection unit 76, the communication device 78, and the indicator 80 are housed in a housing 20h of the position detection device 20. The connector 82 is provided at the housing 20h in such a way that part of the connector 82 is exposed on the outer surface of the housing 20h.

The sensor module 30 has a second sensor 90 and a connector 92. The second sensor 90 is housed in a housing 30h of the sensor module 30. The connector 92 is provided at the housing 30h in such a way that part of the connector 92 is exposed on the outer surface of the housing 30h.

Compared to the position detection device 20, the sensor module 30 includes significantly fewer components. Therefore, the sensor module 30 is extremely smaller than the position detection device 20. Therefore, an area occupied by the sensor module 30 when the sensor module 30 is attached to the cylinder 40 can be much smaller than the position detection device 20.

The antenna 72 of the position detection device 20 receives power from the wireless power supply device 60 wirelessly. The power conversion circuit 74 converts the power received by the antenna 72. The power conversion circuit 74 converts, for example, AC power into DC power. The power converted by the power conversion circuit 74 is supplied to the first sensor 70, the detection unit 76, the communication device 78, and the indicator 80. Line connections for the power supplied to the detection unit 76, the communication device 78, and the indicator 80 are schematically illustrated in FIG. 1.

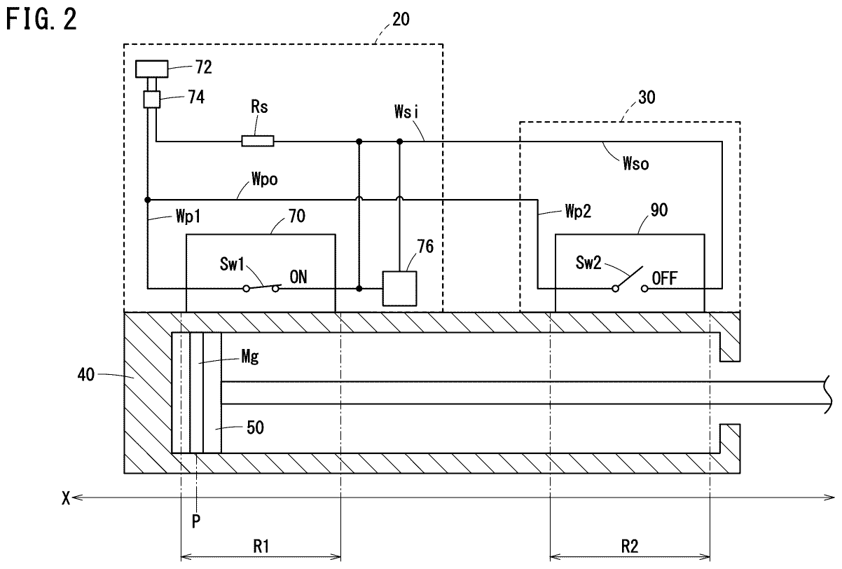

The position detection device 20 further has a power supply line Wp1. The power supply line Wp1 connects the power conversion circuit 74 and the first sensor 70. When the magnet Mg of the piston 50 is located within a first detection range R1 due to the movement of the piston 50 in the X direction, the piston position P is located within the first detection range R1. In that case, the first sensor 70 is turned on. The configuration of the first sensor 70 will be described later with reference to FIGS. 2 to 5.

When the first sensor 70 is turned on, power is supplied from the antenna 72 to the first sensor 70 via the power conversion circuit 74 through the power supply line Wp1. The power supplied to the first sensor 70 is consumed at a load resistor Rs. Thus, the voltage output from the first sensor 70 is obtained as the above-described first detection signal output from the first sensor 70. That is, when the magnet Mg of the piston 50 is located within the first detection range R1, the first sensor 70 outputs the first detection signal.

The detection unit 76 includes an electronic circuit such as a CPU (Central Processing Unit). The detection unit 76 acquires the first detection signal output from the first sensor 70. The detection unit 76 detects the piston position P based on the first detection signal. That is, the detection unit 76 detects that the piston position P is located within the first detection range R1. The communication device 78 transmits the piston position P detected by the detection unit 76 to the external device 62. The communication between the communication device 78 and the external device 62 may be wireless communication or wired communication.

The indicator 80 has a first lamp 80a and a second lamp 80b that emit light in different colors. The power wirelessly supplied from the wireless power supply device 60 may be weak. To suppress the power consumption, the first lamp 80a and the second lamp 80b emit light intermittently. When the piston position P is detected based on the first detection signal by the detection unit 76, the indicator 80 turns on the first lamp 80a and then turns it off. The indicator 80 makes the first lamp 80a blink by repeatedly turning on and off the first lamp 80a. That is, the first lamp 80a intermittently emits light.

The position detection device 20 further has a power output line Wpo. One end of the power output line Wpo is connected to the power conversion circuit 74 whereas the other end of the power output line Wpo is connected to the connector 82. The cable Cb connecting the position detection device 20 and the sensor module 30 can be attached to the connector 82. When the magnet Mg of the piston 50 is located outside the first detection range R1 and the second sensor 90 in the sensor module 30 is ON, the power output line Wpo can externally output to the sensor module 30 the power received by the antenna 72 and converted by the power conversion circuit 74. The externally output power may be supplied to the second sensor 90 as described later.

As described above, when the magnet Mg of the piston 50 is located within the first detection range R1, the power received by the antenna 72 is supplied to the first sensor 70 through the power supply line Wp1. When the magnet Mg of the piston 50 is located outside the first detection range R1 and the second sensor 90 is on, the power received by the antenna 72 can be externally output to the sensor module 30 through the power output line Wpo and supplied to the second sensor 90.

That is, wasteful power supply is prevented in which the wirelessly supplied power is supplied to both the first sensor 70 and the second sensor 90. This can reduce the possibility of the shortage of wirelessly supplied power.

The above-described cable Cb can be attached to the connector 92 of the sensor module 30. In the example shown in FIG. 1, one end of the cable Cb is attached to the connector 82 of the position detection device 20 whereas the other end of the cable Cb is attached to the connector 92 of the sensor module 30. The cable Cb houses an output line Cbo extending from the position detection device 20 to the sensor module 30 and an input line Cbi extending from the sensor module 30 to the position detection device 20. The above-mentioned power output line Wpo is connected, via the connector 82, to the output line Cbo housed in the cable Cb.

The sensor module 30 further has a power supply line Wp2. The power supply wiring Wp2 connects the connector 92 with the second sensor 90. The power supply wiring Wp2 is connected, via the connector 92, to the output line Cbo housed in the cable Cb. When the magnet Mg of the piston 50 is located within the second detection range R2 due to the movement of the piston 50 in the X direction, the piston position P is located within the second detection range R2. In that case, the second sensor 90 is turned on. The configuration of the second sensor 90 will be described later with reference to FIGS. 2 to 5.

When the second sensor 90 is turned on, power is supplied from the antenna 72 of the position detection device 20 to the second sensor 90 via the power conversion circuit 74 through the power output line Wpo and the connector 82 of the position detection device 20, the output line Cbo in the cable Cb, and the connector 92 and the power supply line Wp2 of the sensor module 30. The voltage output from the second sensor 90 is obtained as the above-described second detection signal output from the second sensor 90. That is, when the magnet Mg of the piston 50 is located within the second detection range R2, the second sensor 90 outputs the second detection signal.

The sensor module 30 further has a signal output wiring Wso. The signal output wiring Wso connects the second sensor 90 and the connector 92. The signal output wiring Wso can externally output the second detection signal to the position detection device 20 via the connector 92 and the cable Cb. The signal output wiring Wso is connected, via the connector 92, to the input line Cbi housed in the cable Cb.

The position detection device 20 further has a signal input wiring Wsi. The signal input wiring Wsi connects the connector 82 and the detection unit 76. The signal input wiring Wsi is connected, via the connector 82, to the input line Cbi housed in the cable Cb. The second detection signal output from the second sensor 90 of the sensor module 30 is supplied to the detection unit 76 through the signal input wiring Wsi.

The detection unit 76 acquires the second detection signal output from the second sensor 90. The detection unit 76 detects the piston position P based on the second detection signal. That is, the detection unit 76 detects that the piston position P is located within the second detection range R2. The communication device 78 transmits the piston position P detected by the detection unit 76 to the external device 62. When the piston position P is detected based on the second detection signal by the detection unit 76, the indicator 80 turns on the second lamp 80b and then turns it off. The indicator 80 makes the second lamp 80b blink by repeatedly turning on and off the second lamp 80b. That is, the second lamp 80b intermittently emits light.

The signal input wiring Wsi is also connected to the load resistor Rs. Thus, the power supplied to the second sensor 90 is consumed at the load resistance Rs.

The first sensor 70 is placed at a position corresponding to one end of the stroke of the piston 50 moving in the X direction, for example. The second sensor 90 is, for example, arranged at a position corresponding to the other end of the stroke of the piston 50 described above. That is, the first sensor 70 of the position detection device 20 is attached to the cylinder 40 at a position apart from the second sensor 90 of the sensor module 30 along the X direction. The first sensor 70 and the second sensor 90 are positioned in a manner so that the first detection range R1 of the position detection device 20 and the second detection range R2 of the sensor module 30 do not overlap in the X direction.

Therefore, when the magnet Mg of the piston 50 is located within the first detection range R1, the first sensor 70 is on while the second sensor 90 is off because the magnet Mg of the piston 50 is not located within the second detection range R2. In this case, the first sensor 70 outputs the first detection signal but the second sensor 90 does not output the second detection signal. Unnecessary power supply to the second sensor 90 is prevented.

When the magnet Mg of the piston 50 is located within the second detection range R2, the second sensor 90 is on while the first sensor 70 is off because the magnet Mg of the piston 50 is not located within the first detection range R1. In this case, the second sensor 90 outputs the second detection signal but the first sensor 70 does not output the first detection signal. Unnecessary power supply to the first sensor 70 is prevented. Thus, there is not a case where both the first sensor 70 and the second sensor 90 are turned on. This can further reduce the possibility of the shortage of wirelessly supplied power.

When the magnet Mg of the piston 50 is located outside the first detection range R1 and outside the second detection range R2, both the first sensor 70 and the second sensor 90 are turned off.

When the first detection signal is output from the first sensor 70, the detection unit 76 detects the piston position P based on the first detection signal. When the piston position P is detected based on the first detection signal by the detection unit 76, the indicator 80 turns on the first lamp 80a. In this case, the second detection signal is not output, and thus the second lamp 80b is not turned on.

When the second detection signal is output from the second sensor 90, the detection unit 76 detects the piston position P based on the second detection signal. When the piston position P is detected based on the second detection signal by the detection unit 76, the indicator 80 turns on the second lamp 80b. In this case, the first detection signal is not output, and thus the first lamp 80a is not turned on. Thus, the piston position P can be detected easily and the piston position P can be notified to a worker who performs an operation using the actuator 10.

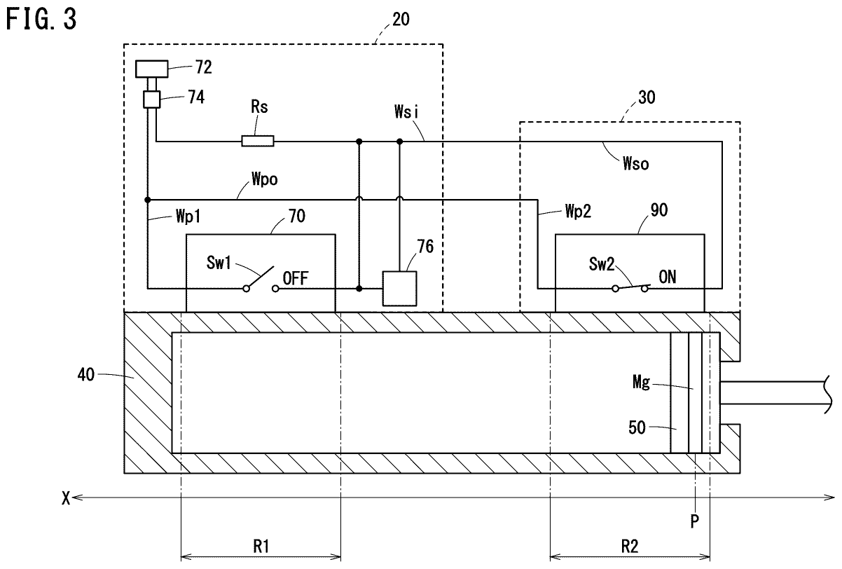

FIGS. 2 and 3 are diagrams for explaining the configuration example of the first sensor 70 and the second sensor 90 and also explaining the power supply to the first sensor 70 and the second sensor 90 according to the piston position P. The illustration of the line connection for the power supplied to the detection unit 76, of the communication device 78, of the indicator 80, and the like is omitted. Both the first sensor 70 and the second sensor 90 shown in FIGS. 2 and 3 are reed switches. Specifically, the first sensor 70 is a reed switch Sw1. The second sensor 90 is a reed switch Sw2. The reed switches Sw1 and Sw2 open and close in response to the magnetism of the magnet Mg provided on the piston 50.

In the example shown in FIG. 2, the piston position P of the piston 50 is included in the first detection range R1. The first detection range R1 of the first sensor 70 is determined based on the piston position P given when the reed switch Sw1 is closed by the magnetism of the magnet Mg of the piston 50. When the piston 50 is located within the first detection range R1, the reed switch Sw1 is closed and turned on.

Thus, power is supplied from the antenna 72 to the reed switch Sw1 via the power conversion circuit 74 and the power supply line Wp1. The power supplied to the reed switch Sw1 is consumed at the load resistor Rs. The voltage is output from the reed switch Sw1 that is turned on. That is, the reed switch Sw1 outputs the first detection signal. The detection unit 76 detects the piston position P based on the first detection signal output from the reed switch Sw1.

The first detection range R1 of the first sensor 70 of the position detection device 20 and the second detection range R2 of the second sensor 90 of the sensor module 30 do not overlap in the X direction. Therefore, in the example shown in FIG. 2, the piston position P is not included in the second detection range R2. The reed switch Sw2, which can be closed by the magnetism of the magnet Mg of the piston 50, is not closed. That is, when the piston 50 is located outside the second detection range R2, the reed switch Sw2 is open and off. Therefore, no power is supplied from the antenna 72 to the reed switch Sw2. The reed switch Sw2 does not output the second detection signal.

In the example shown in FIG. 3, the piston position P of the piston 50 is included in the second detection range R2. The second detection range R2 of the second sensor 90 is determined based on the piston position P given when the reed switch Sw2 is closed by the magnetism of the magnet Mg of the piston 50. When the piston 50 is located within the second detection range R2, the reed switch Sw2 is closed and turned on.

Thereby, power is supplied from the antenna 72 to the reed switch Sw2 via the power conversion circuit 74, the power output line Wpo, and the power supply line Wp2. The power supplied to the reed switch Sw2 is consumed at the load resistor Rs. The voltage is output from the reed switch Sw2 that has been turned on. That is, the reed switch Sw2 outputs the second detection signal. The detection unit 76 detects the piston position P based on the second detection signal output from the reed switch Sw2.

In the example shown in FIG. 3, the piston position P is not included in the first detection range R1. The reed switch Sw1, which can be closed by the magnetism of the magnet Mg of the piston 50, is not closed. That is, when the piston 50 is located outside the first detection range R1, the reed switch Sw1 is open and off. Therefore, no power is supplied from the antenna 72 to the reed switch Sw1. The reed switch Sw1 does not output the first detection signal.

As described above, the reed switch Sw1 is turned on when the piston 50 is located within the first detection range R1, and outputs the first detection signal. The reed switch Sw1 is turned off when the piston 50 is located outside the first detection range R1, and does not output the first detection signal. Thus, it is possible to detect in a simple manner whether the piston position P is located within the first detection range R1.

As described above, the reed switch Sw2 is turned on when the piston 50 is located within the second detection range R2, and outputs the second detection signal. The reed switch Sw2 is turned off when the piston 50 is located outside the second detection range R2, and does not output the second detection signal. Thus, it is possible to detect in a simple manner whether the piston position P is located within the second detection range R2.

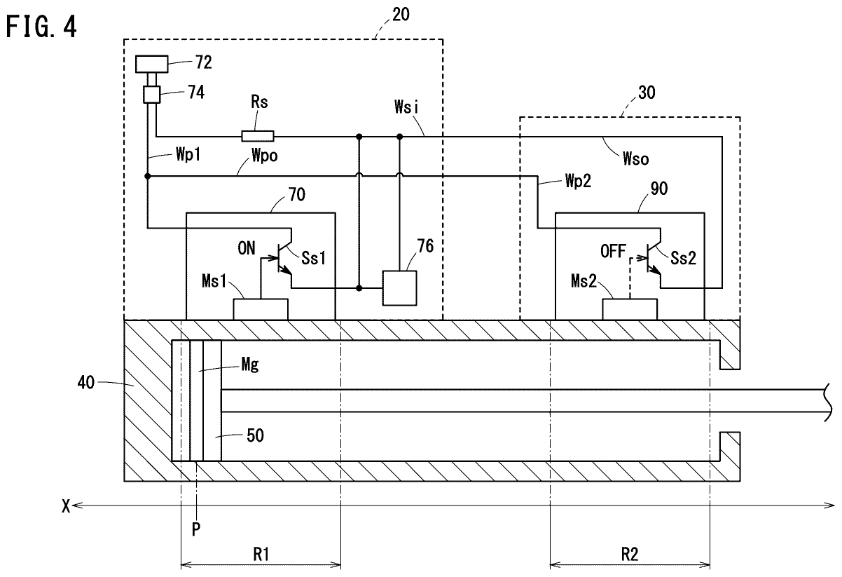

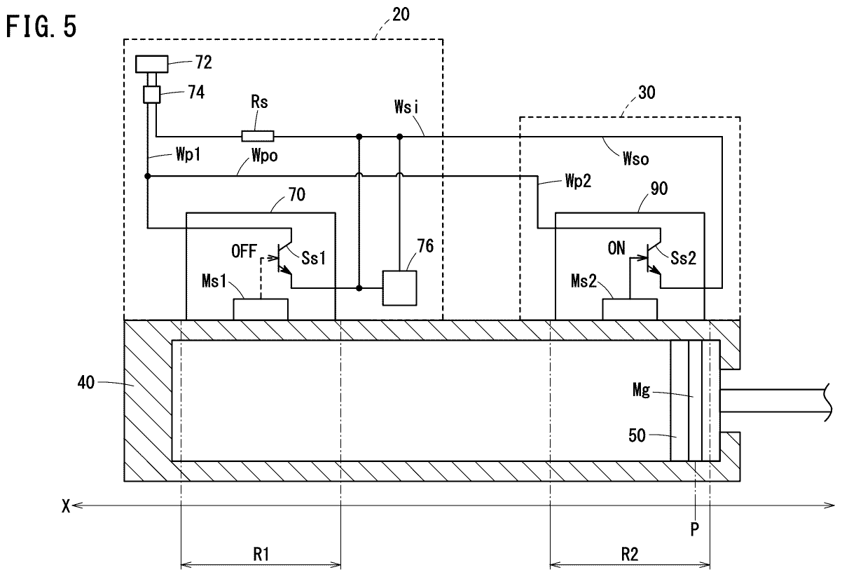

Switches other than the reed switches Sw1 and Sw2 may be used as the first sensor 70 and the second sensor 90. FIGS. 4 and 5 are diagrams for explaining another example of the configuration of the first sensor 70 and the second sensor 90 and explaining the power supply to the first sensor 70 and the second sensor 90 according to the piston position P. The illustration of the line connection for the power supplied to the detection unit 76, of the communication device 78, of the indicator 80, and the like is omitted.

Both the first sensor 70 and the second sensor 90 shown in FIGS. 4 and 5 include a magnetic sensor and a semiconductor switch. Specifically, the first sensor 70 includes a magnetic sensor Ms1 and a semiconductor switch Ss1. The second sensor 90 includes a magnetic sensor Ms2 and a semiconductor switch Ss2. The magnetic sensors Ms1 and Ms2 output electric signals corresponding to current or voltage in accordance with the magnetism of the magnets Mg provided at the piston 50. The magnetic sensors Ms1 and Ms2 are, for example, magneto-resistive (MR) elements, Hall elements, or the like.

The electric signal output from the magnetic sensor Ms1 is input to the semiconductor switch Ss1, whereby the semiconductor switch Ss1 is turned on. The electric signal output from the magnetic sensor Ms2 is input to the semiconductor switch Ss2, whereby the semiconductor switch Ss2 is turned on.

In the example shown in FIG. 4, the piston position P of the piston 50 is included in the first detection range R1. A first detection range R1 of the first sensor 70 is determined based on the piston position P when the electric signal is output from the magnetic sensor Ms1 due to the magnetism possessed by the magnet Mg of the piston 50. When the piston 50 is located within the first detection range R1, the electric signal is output from the magnetic sensor Ms1, and the semiconductor switch Ss1 is turned on.

Thus, power is supplied from the antenna 72 to the semiconductor switch Ss1 via the power conversion circuit 74 and the power supply line Wp1. The power supplied to the semiconductor switch Ss1 is consumed at the load resistor Rs. Voltage is output from the semiconductor switch Ss1 that has been turned on. That is, the semiconductor switch Ss1 outputs the first detection signal. The detection unit 76 detects the piston position P based on the first detection signal output from the semiconductor switch Ss1.

The first detection range R1 of the first sensor 70 of the position detection device 20 and the second detection range R2 of the second sensor 90 of the sensor module 30 do not overlap in the X direction. Therefore, in the example shown in FIG. 4, the piston position P is not included in the second detection range R2. The electric signal that can be output from the magnetic sensor Ms2 to the semiconductor switch Ss2 due to the magnetism of the magnet Mg of the piston 50 is not output.

That is, when the piston 50 is located outside the second detection range R2, no electric signal is input from the magnetic sensor Ms2 to the semiconductor switch Ss2, and the semiconductor switch Ss2 is off. Therefore, no power is supplied from the antenna 72 to the semiconductor switch Ss2. The semiconductor switch Ss2 does not output the second detection signal.

In the example shown in FIG. 5, the piston position P of the piston 50 is included in the second detection range R2. The second detection range R2 of the second sensor 90 is determined based on the piston position P given when the electric signal is output from the magnetic sensor Ms2 due to the magnetism possessed by the magnet Mg of the piston 50. When the piston 50 is located within the second detection range R2, the electric signal is output from the magnetic sensor Ms2, and the semiconductor switch Ss2 is turned on.

Thus, power is supplied from the antenna 72 to the semiconductor switch Ss2 via the power conversion circuit 74, the power output line Wpo, and the power supply line Wp2. The power supplied to the semiconductor switch Ss2 is consumed at the load resistor Rs. The voltage is output from the semiconductor switch Ss2 that has been turned on. That is, the semiconductor switch Ss2 outputs the second detection signal. The detection unit 76 detects the piston position P based on the second detection signal output from the semiconductor switch Ss2.

In the example shown in FIG. 5, the piston position P is not included in the first detection range R1. The electric signal that can be output from the magnetic sensor Ms1 to the semiconductor switch Ss1 due to the magnetism of the magnet Mg of the piston 50 is not output. That is, when the piston 50 is located outside the first detection range R1, no electric signal is input from the magnetic sensor Ms1 to the semiconductor switch Ss1, and the semiconductor switch Ss1 is off. Therefore, no power is supplied from the antenna 72 to the semiconductor switch Ss1. The semiconductor switch Ss1 does not output the first detection signal.

As described above, when the piston 50 is located within the first detection range R1, the magnetic sensor Ms1 outputs the electric signal, and the semiconductor switch Ss1 is turned on to output the first detection signal. When the piston 50 is located outside the first detection range R1, the magnetic sensor Ms1 does not output an electric signal, and the semiconductor switch Ss1 is turned off to not output the first detection signal. Thus, it is possible to detect in a simple manner whether the piston position P is located within the first detection range R1.

As described above, when the piston 50 is located within the second detection range R2, the magnetic sensor Ms2 outputs the electric signal, and the semiconductor switch Ss2 is turned on to output the second detection signal. When the piston 50 is located outside the second detection range R2, the magnetic sensor Ms2 does not output an electric signal, and the semiconductor switch Ss2 is turned off to not output the second detection signal. Thus, it is possible to detect in a simple manner whether the piston position P is located within the second detection range R2.

With respect to the above embodiments, we further disclose the following supplementary notes.

### Supplementary Note 1

A position detection device (20) for detecting a piston position (P) of a piston (50) that is attached to a cylinder (40) and moves in the cylinder includes a first sensor (70) that outputs a first detection signal in a case where the piston is located within a first detection range (R1), a detection unit (76) that detects the piston position based on the first detection signal, a communication device (78) that transmits the piston position detected by the detection unit to an external device (62), an antenna (72) that receives power wirelessly, a power supply line (Wp1) through which the power is supplied from the antenna to the first sensor in a case where the piston is located within the first detection range, and a power output line (Wpo) configured to externally output, in a case where the piston is located outside the first detection range, the power to a sensor module (30) used for detecting the piston position. Such a configuration can reduce the possibility of the shortage of wirelessly supplied power.

### Supplementary Note 2

The position detection device according to Supplementary note 1 may be configured in such a way that the piston is provided with a magnet (Mg), and the first sensor is a reed switch (Sw1) that is turned on to output the first detection signal in a case where the piston is located within the first detection range and that is turned off to not output the first detection signal in a case where the piston is located outside the first detection range. According to such a configuration, it is possible to detect in a simple manner whether the piston position is located within the first detection range.

### Supplementary Note 3

The position detection device according to Supplementary note 1 may be configured in such a way that the piston is provided with a magnet, the first sensor includes a magnetic sensor (Ms1) that outputs an electric signal in a case where the piston is located within the first detection range, and a semiconductor switch (Ss1) that is turned on by input of the electric signal and outputs the first detection signal, and in a case where the piston is located outside the first detection range, the magnetic sensor does not output the electric signal, and the semiconductor switch is turned off due to absence of the input of the electric signal and does not output the first detection signal. According to such a configuration, it is possible to detect in a simple manner whether the piston position is located within the first detection range.

### Supplementary Note 4

The position detection device according to Supplementary note 1 may be configured in such a way that the sensor module includes a second sensor (90) that outputs a second detection signal in a case where the piston is located within a second detection range (R2), the first sensor is attached to the cylinder at a position apart from the second sensor along the movement direction (X) of the piston, and the first sensor and the second sensor are positioned in a manner so that the first detection range and the second detection range do not overlap in the movement direction. Such a configuration can further reduce the possibility of the shortage of wirelessly supplied power.

### Supplementary Note 5

The position detection device described in Supplementary note 1 may further include a connector (82) to which a cable (Cb) connecting the position detection device and the sensor module is attachable, wherein the power output wiring may be connected to the connector. According to such a configuration, the wirelessly supplied power can be externally output to the sensor module.

### Supplementary Note 6

The position detection device according to Supplementary note 5 may further include a signal input line (Wsi) that connects the connector and the detection unit, wherein the sensor module may include a second sensor that outputs a second detection signal in a case where the piston is located within a second detection range, the second detection signal output from the second sensor may be supplied to the detection unit through the signal input line, and the detection unit may detect the piston position based on the second detection signal. According to such a configuration, it is possible to detect whether the piston position is located within the second detection range.

### Supplementary Note 7

The position detection device according to Supplementary note 4 may be configured in such a way that the detection unit detects the piston position based on the first detection signal in a case where the first detection signal is output from the first sensor, and detects the piston position based on the second detection signal in a case where the second detection signal is output from the second sensor. According to such a configuration, the piston position can be easily detected.

### Supplementary Note 8

The position detection device described in Supplementary note 7 may further include an indicator (80) that includes a first lamp (80a) and a second lamp (80b) that emit light in different colors, wherein the indicator may turn on the first lamp in a case where the piston position is detected based on the first detection signal by the detection unit, and the indicator may turn on the second lamp in a case where the piston position is detected based on the second detection signal by the detection unit. Thus, the piston position can be informed to a worker who performs an operation using the actuator.

### Supplementary Note 9

An actuator (10) is provided with the position detection device described in supplementary note 4, the sensor module described in supplementary note 4, the cylinder described in supplementary note 4, and the piston described in supplementary note 4. Such a configuration can reduce the possibility of the shortage of wirelessly supplied power during an operation using the actuator.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiments, the order of the operations and the order of the processes are shown as an example, and are not limited to these examples. The same applies to the case where numerical values or mathematical expressions are used in the description of the above-described embodiments.

1. A position detection device for detecting a piston position of a piston that is attached to a cylinder and moves in the cylinder, the position detection device comprising:
a first sensor that outputs a first detection signal in a case where the piston is located within a first detection range;
a detection unit that detects the piston position based on the first detection signal;
a communication device that transmits the piston position detected by the detection unit to an external device;
an antenna that receives power wirelessly;
a power supply line through which the power is supplied from the antenna to the first sensor in a case where the piston is located within the first detection range; and
a power output line configured to externally output, in a case where the piston is located outside the first detection range, the power to a sensor module used for detecting the piston position.

2. The position detection device according to claim 1, wherein
the piston is provided with a magnet, and
the first sensor is a reed switch that is turned on to output the first detection signal in a case where the piston is located within the first detection range and that is turned off to not output the first detection signal in a case where the piston is located outside the first detection range.

3. The position detection device according to claim 1, wherein
the piston is provided with a magnet,
the first sensor includes a magnetic sensor that outputs an electric signal in a case where the piston is located within the first detection range, and a semiconductor switch that is turned on by input of the electric signal and outputs the first detection signal, and
in a case where the piston is located outside the first detection range, the magnetic sensor does not output the electric signal, and the semiconductor switch is turned off due to absence of the input of the electric signal and does not output the first detection signal.

4. The position detection device according to claim 1, wherein
the sensor module includes a second sensor that outputs a second detection signal in a case where the piston is located within a second detection range,
the first sensor is attached to the cylinder at a position apart from the second sensor along a moving direction of the piston, and
the first sensor and the second sensor are positioned in a manner so that the first detection range and the second detection range do not overlap in the moving direction.

5. The position detection device according to claim 1, further comprising
a connector to which a cable connecting the position detection device and the sensor module is attachable,
wherein the power output line is connected to the connector.

6. The position detection device according to claim 5, further comprising
a signal input line that connects the connector and the detection unit,
wherein the sensor module includes a second sensor that outputs a second detection signal in a case where the piston is located within a second detection range,
the second detection signal output from the second sensor is supplied to the detection unit through the signal input line, and
the detection unit detects the piston position based on the second detection signal.

7. The position detection device according to claim 4, wherein
the detection unit detects the piston position based on the first detection signal in a case where the first detection signal is output from the first sensor, and detects the piston position based on the second detection signal in a case where the second detection signal is output from the second sensor.

8. The position detection device according to claim 7, further comprising
an indicator that includes a first lamp and a second lamp that emit light in different colors,
wherein the indicator turns on the first lamp in a case where the piston position is detected based on the first detection signal by the detection unit, and
the indicator turns on the second lamp in a case where the piston position is detected based on the second detection signal by the detection unit.

9. An actuator comprising:
the position detection device according to claim 4;
the sensor module according to claim 4;
the cylinder according to claim 4; and
the piston according to claim 4.
